(19) United States
(12) Patent Application Publication
(10) Pub. No.: US 2011/0302222 A1
(43) Pub. Date: Dec. 8, 2011

(54) SYSTEM, METHOD AND COMPUTER PROGRAM PRODUCT FOR CREATING A CHILD DATABASE OBJECT USING A CHILD DATABASE OBJECT TYPE IDENTIFIED FROM A PARENT DATABASE OBJECT

(75) Inventors: John Kucera, San Francisco, CA (US); Vrushali V. Patil, San Francisco, CA (US); Peitao Ting, Danville, CA (US); Albert Taruc, San Francisco, CA (US); Judy Feng, San Bruno, CA (US)

(73) Assignee: salesforce.com, inc., San Francisco, CA (US)

(21) Appl. No.: 13/155,305

(22) Filed: Jun. 7, 2011

Related U.S. Application Data
(60) Provisional application No. 61/352,299, filed on Jun. 7, 2010.

(51) Int. Cl. G06F 17/30

(52) U.S. Cl. 707/805; 707/803; 707/E17.055

(57) ABSTRACT

In accordance with embodiments, there are provided mechanisms and methods for creating a child database object using a child database object type identified from a parent database object. These mechanisms and methods for creating a child database object using a child database object type identified from a parent database object can enable embodiments to provide creation of a child database object according to a type configured with respect to an associated parent database object. The ability of embodiments to provide such configuration in the parent database object can enable any associated child database objects to be created according to the type configured with respect to the parent database object.

### CLAIM OF PRIORITY

This application claims the benefit of U.S. Provisional Patent Application 61/352,299 entitled “Methods And Systems For Tracking A Campaign In A Multi-Tenant Database Environment,” by Kucera et al., filed Jun. 7, 2010 (SFC1β138+/409βROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to creating objects in a database system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, objects are created for storage in database, such as in tables of the database. Each of the objects typically includes a record (i.e. row) in one of the tables, and stores data in fields of the record. Accordingly, an object is generally configured during creation to be of a certain type which corresponds to the particular data to be stored by the object, such that a format of the object (i.e. the particular fields included, etc.) is dependent on the data to be stored. Unfortunately, traditional techniques for configuring data object types have been limited.

For example, a type must generally be configured for each object during creation of the object, such that the object is created using the configured type. This requires an object type parameter to be set for each object being created, which can become cumbersome when numerous objects are being created. Accordingly, it is desirable to provide techniques enabling an automated configuration of a database object type for use in creating a database object, particularly where the database object to be created is a child of a parent database object.

### BRIEF SUMMARY

In accordance with embodiments, there are provided mechanisms and methods for creating a child database object using a child database object type identified from a parent database object. These mechanisms and methods for creating a child database object using a child database object type identified from a parent database object can enable embodiments to provide creation of a child database object according to a type configured with respect to an associated parent database object. The ability of embodiments to provide such configuration in the parent database object can enable any associated child database objects to be created according to the type configured with respect to the parent database object.

In an embodiment and by way of example, a method for creating a child database object using a child database object type identified from a parent database object is provided. In use, a request to create a child database object from a parent database object is received in a multi-tenant on-demand database system. Additionally, a child database object type configured for the parent database object is identified from the parent database object. Furthermore, the child database object is created using the child database object type identified from the parent database object.

While one or more implementations and techniques are described with reference to an embodiment in which creating a child database object using a child database object type identified from a parent database object is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for creating a child database object using a child database object type identified from a parent database object, in accordance with an embodiment;

FIG. 2 illustrates a method for configuring a child database object type for a parent database object, in accordance with an embodiment;

FIG. 3 illustrates a method for creating a child database object for a parent database object, in accordance with an embodiment;

FIG. 4 illustrates database tables storing a child database object creating using a child database object type identified from a stored parent database object, in accordance with an embodiment;

FIGS. 5A-C illustrate graphical user interfaces (GUIs) for use in creating a child database object using a child database object type identified from a parent database object, in accordance with an embodiment;

FIG. 6 illustrates a block diagram of an example of an environment wherein an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for creating a child database object using a child database object type identified from a parent database object.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing creating a child database object using a child database object type identified from a parent database object will be described with reference to example embodiments.

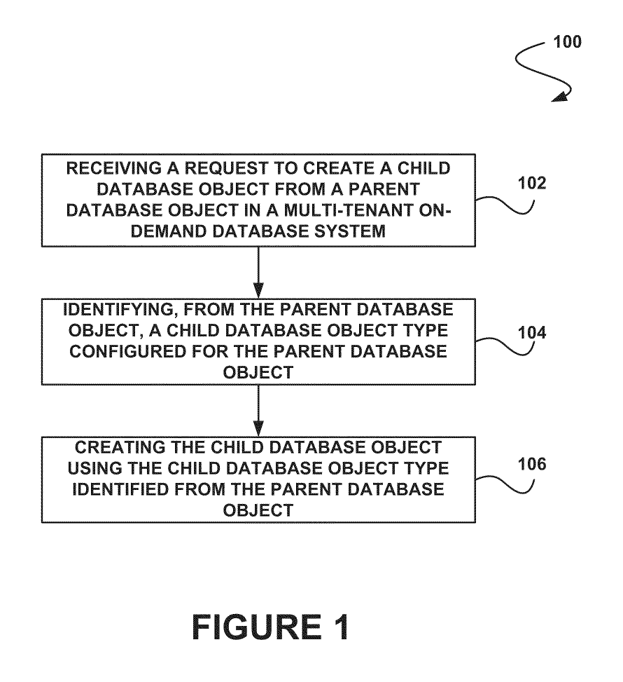

FIG. 1 illustrates a method 100 for creating a child database object using a child database object type identified from a parent database object, in accordance with an embodiment. As shown in operation 102, a request to create a child database object from a parent database object is received in a multi-tenant on-demand database system. In the context of the present description, the parent database object includes any object ('e.g. record, row, etc.) stored by the multi—tenant on—demand database system which is at least capable of having, if it does not already have, at least one child database object. Thus, the parent database object may be of a particular type that is predetermined to be capable of being a parent to at least one child database object.

In one embodiment, the parent database object may be stored in a table (i.e. database table) of the multi-tenant on-demand database system. Such table may optionally store all parent database objects of the same particular type. Further, the aforementioned parent-child relationship between the parent database object and any child database object(s) may be provided via a reference in the child database object to the stored parent database object, in one embodiment.

To this end, the child database object which is requested to be created may include any object (e.g. record, row, etc.) which is a child of the parent database object. For example, the child database object may be the child of the parent database object by virtue of a reference in the child database object to the parent database object. Details regarding the creation of the child database object are provided below.

As noted above, a request to create a child database object from the parent database object is received in a multi-tenant on-demand database system. As an option, the request may be received from a graphical user interface (GUI) associated with the parent database object (e.g. and displayed by the multi-tenant on-demand database system). Just by way of example, the GUI may display details describing the parent database object, and may further include a selectable option for creating a child database object for the parent database object. Thus, selection of the option provided by the GUI may result in receipt of the request to create the child database object from the parent database object. Of course, however, it should be noted that the request may be received in any manner that indicates that the child database object is to be created from the parent database object.

Additionally, as shown in operation 104, a child database object type configured for the parent database object is identified from the parent database object. In the context of the present description, the child database object type may include any type of child database object which may be used to create the requested child database object, as described in more detail below.

In one embodiment, the child database object type may be a format for the child database object. For example, the child database object type may indicate fields of the child database object. As another example, the child database object type may indicate a page layout utilized for presenting the child database object (e.g. data included therein) to a user. In another embodiment, the child database object type may indicate a type of data stored by the child database object, such as a type of data allowed to be stored by the field of the child database object. Thus, the child database object type may be an object template according to which the child database object is to be created.

As noted above, the child database object type is configured for the parent database object, such that that the child database object type is identifiable from the parent database object (i.e. from a field of the parent database object storing an indicator of the child database object type configured for the parent database object). As an option, a plurality of child database object types may be predetermined to be associated with a type of the parent database object, such that the child database object type may be configured by the user selecting the child database object type from the plurality of predetermined child database object types. To this end, the child database object type may optionally be configured by a user during creation of the parent database object, and may be one of a plurality of predetermined types of child database objects capable of being associated with the parent database object.

Still yet, the child database object type may be configured for the parent database object such that all child database objects of the parent database object are configured to be of the child database object type. Accordingly, all child database objects of the parent database object may be of a same type, namely the child database object type configured for the parent database object. In one embodiment, the child database object type may be configured for the parent database object separate from a configured type of the parent database object. In this way, the child database object type may be different from the type of the parent database object.

Furthermore, as shown in operation 106, the child database object is created using the child database object type identified from the parent database object. For example, the child database object may be created according to the child database object type identified from the parent database object. In this way, the created child database object may be of the child database object type identified from the parent database object.

In one embodiment, creating the child database object using the child database object type may include formatting the child database object according to the child database object type. Just by way of example, the child database object may be created to include fields (e.g. of a particular type) specified by the child database object type. As another example, the child database object may be created to include data specified by the child database object type, such as a reference to the parent database object.

Moreover, the child database object may be created in a table of the multi-tenant on-demand database system. Optionally, the child database object may be created in a first table of the multi-tenant on-demand database system separate from a second table of the multi-tenant on demand database system storing the parent database object. Thus, any reference to the parent database object stored by the child database object may include a reference to another table of the multi-tenant on-demand database system.

By creating the child database object using the child database object type identified from the parent database object, the child database object may be created automatically using information stored by the parent database object. In this way, a user may avoid having to enter or otherwise select a type for each child database object created from the parent database object. Additionally, it may be ensured that all child database objects of a single parent database object are of the same type, as configured with respect to such single parent database object.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

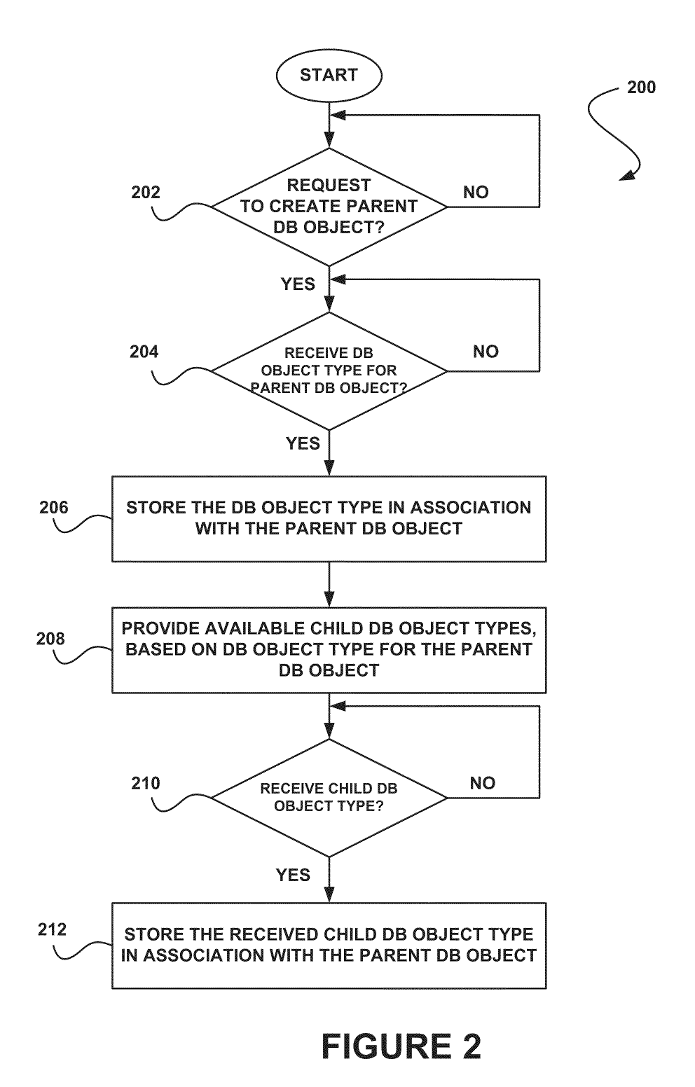

FIG. 2 illustrates a method 200 for configuring a child database object type for a parent database object, in accordance with an embodiment. As an option, the present method 200 may be carried out in the context of the functionality of FIG. 1. For example, the method 200 may be carried out by the multi-tenant on-demand database system described herein. Of course, however, the method 200 may be carried out in any desired environment. The aforementioned definitions may apply during the present description.

As shown in decision 202, it is determined whether a request to create a parent database object has been received. In the present embodiment, the parent database object includes any database object of a particular category that is predetermined to be capable of having at least one child database object. Thus, it may be determined whether a request to create an object of such particular category has been received.

It should be noted that the request may be received by a user, such as a user associated with a tenant account of a multi-tenant on-demand database system. In one embodiment, the request may be received via a GUI of the multi-tenant on-demand database system. In one exemplary embodiment, the parent database object may be a campaign database object utilized for storing information associated with a campaign of an entity (e.g. business organization, the tenant of the multi-tenant on-demand database system, etc.).

If it is determined that a request to create a parent database object has not been received, the method 200 continues to wait for such a request. Once it is determined that a request to create a parent database object has not been received, it is further determined whether a database object type for the parent database object has been received. Note decision 204. The database object type may include a particular type for the parent database object, for example, which may define a format for the parent database object, fields of the parent database object, data stored by the parent database object, etc.

In one embodiment, the database object type may be received by the user inputting the database object type for the parent database object. As an option, the database object type may be input by the user via a GUI of the multi-tenant on-demand database system. For example, the user may select the database object type from a list of database object types, where such list of database object types may include database object types predetermined to be associated with the particular category of the parent database object.

With respect to the exemplary embodiment above where the parent database object is a campaign database object, the database object type may include initiative (e.g. indicating that the campaign described by the campaign database object is a mild level campaign consisting of multiple tactics), program (e.g. indicating that the campaign described by the campaign database object is a top level campaign consisting of multiple initiatives), or a tactic (e.g. indicating that the campaign described by the campaign database object is an item, such as an email, landing page, webinar, press release, etc.). It should be noted that in addition to the database object type, other parameters may also be configured for the parent database object by the user, such as a name of the parent database object. Furthermore, some parameters may be automatically configured for the parent database object by the database system (e.g. the multi-tenant on-demand database system) used for storing the parent database object, such as a unique identifier for the parent database object.

If it is determined that a database object type for the parent database object has not been received, the method 200 continues to wait for receipt of the database object type for the parent database object. Reasons for such waiting will become apparent below. Once it is determined that a database object type for the parent database object has been received, the database object type is stored in association with the parent database object, as shown in operation 206. For example, the database object type may be stored in a field of the parent database object.

Still yet, as shown in operation 208, available child database object types are provided, based on the database object type for the parent database object. In one embodiment, each database object type may be predetermined to be associated with one or more child database object types. Such child database object types may include types of database objects which are predetermined to be capable of being a child of the parent database object. In this way, the available child database object types may include child database object types which have been predetermined to be associated to be associated with the database object type of the parent database object. In the example above where the parent database object is a campaign database object, the database object type of the campaign may be tactic, and further the available child database object types may include adwords, direct mail, or email.

As noted above, the method 200 may not necessarily provide the available child database object types until the database object type is received for the parent database object. In one embodiment, the available child database object types may be provided to the user via a GUI of the multi-tenant on-demand database system. For example, the available child database object types may be displayed in a list to the user, for selection of one of such available child database object types.

It is then determined whether a child database object type has been received, as shown in decision 210. For example, it may be determined whether one of the available child database object types has been selected. If it is determined that child database object type has not been received, the method 200 continues to wait for a child database object type to be received.

Once it is determined that a child database object type has been received, the received child database object type is stored in association with the parent database object. Note operation 212. For example, the child database object type may be stored in a field of the parent database object. By storing the child database object type in association with the parent database object, any child database object created from the parent database object may automatically be configured (e.g. without further user input) to be of the child database object type stored in association with the parent database object.

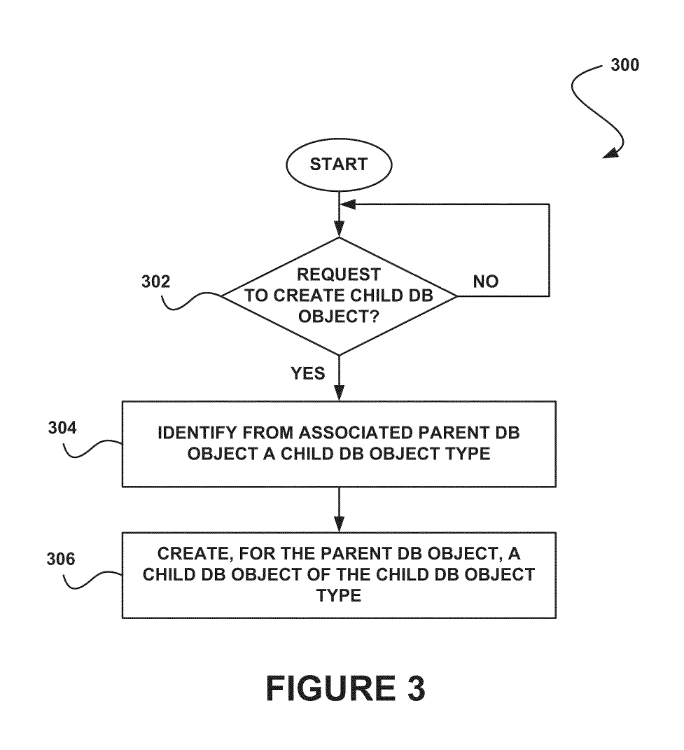

FIG. 3 illustrates a method 300 for creating a child database object for a parent database object, in accordance with an embodiment. As an option, the present method 300 may be carried out in the context of the functionality of FIGS. 1-2. Of course, however, the method 300 may be carried out in any desired environment. Again, the aforementioned definitions may apply during the present description.

As shown in decision 302, it is determined whether a request to create a child database object has been received. In the present embodiment, the child database object may include an object that is a child of a parent database object, such as the parent database object created using the method 200 of FIG. 2. A request to create such child database object may be received from a GUI displaying details associated with the parent database object from which it is to be created.

If it is determined that a request to create a child database object has not been received, the method 300 continues to wait for such a request to be received. If, however, it is determined that a request to create a child database object has been received, a child database object type is identified from the associated parent database object (e.g. from which the child database object has been requested to be created). Note operation 304. For example, the child database object type may be identified from a child database object type field storing the child database object type configured for the parent database object.

Furthermore, a child database object of the child database object type is created for the parent database object, as shown in operation 306. Creation of such child database object may include storing the child database object in a table of a multi-tenant on-demand database system, in one embodiment. The child database object is created according to the child database object type, as noted above, which may include, for example, formatting the child database object according to a format indicated by the child database object type, configuring fields of the child database object according to the child database object type, storing data in the child database object according to the child database object type, etc. In this way, the child database object created from the parent database object may automatically be configured to be of a child database object type indicated by the parent database object.

In one exemplary use case, database users in a marketing department may create campaigns to generate interest and get people to sign up to be contacted later. Each campaign may be stored in a database as a record categorized as a campaign. Each person that signs up to be contacted may be stored in the database as a record categorized as a lead in order to track how each person was contacted and what they did. Thus, the lead may be a child database object (e.g. a member) of the campaign record.

For each database record, a creator of the database record (or other user having permission to edit the database record) may specify a type of the database record. Such type may dictate a page layout defining which data of the record is shown on a page specific to the record. For example, if a campaign is an email that is sent to some people, then the campaign record is of the email type which may dictate that the page layout for the campaign record includes information on whether the email was sent, whether a receiver of the email opened the email, whether the receiver of the email clicked on a link in the email, etc. As another example, if a campaign is a tradeshow attended by people, then the campaign record is of the tradeshow type which may dictate that the page layout for the campaign record includes information on which invitees RSVP'd, attended, did not attend, etc.

Instead of having the database record creators/editors select the child record type every time a child record is added to the campaign record, the child record type can instead be selected only once for the campaign record and every child record of that campaign record may be configured to be of the child record type automatically. Instead of copying the child record type to each child record, each child record may reference the campaign record, and specifically the child record type configured for and stored by the campaign record, such that when loading up the page for a child record the child record type may be obtained from the parent campaign record and the information dictated by the obtained child record type may be presented on the page.

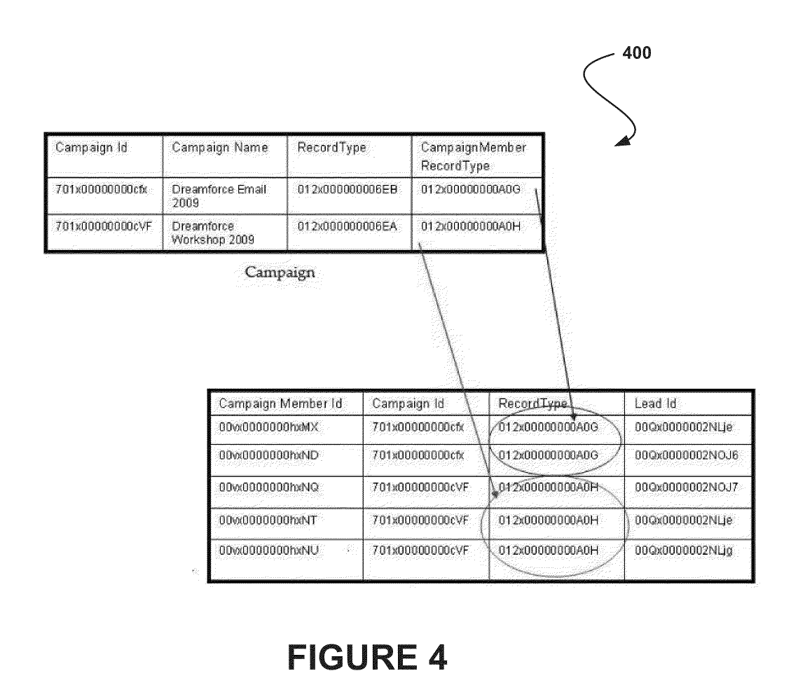

FIG. 4 illustrates database tables 400 storing a child database object creating using a child database object type identified from a stored parent database object, in accordance with an embodiment. As an option, the database tables 400 may be implemented in the context of the functionality of FIGS. 1-3. For example, the database tables 400 may be stored by the multi-tenant on-demand database system described herein. Of course, however, the database tables 400 may be implemented in any desired environment. Again, the aforementioned definitions may apply during the present description.

As shown, a first database table stores parent database objects. In the embodiment shown, the database table storing parent database objects only stores parent database objects of a single category (i.e. campaign). Thus, as an option, separate tables may be provided, each for storing parent database objects of a single category.

The parent database objects include various common fields. As shown, such fields are used to store a campaign id (i.e. a unique identifier of the parent database object), a campaign name, a database object type of the parent database object, and a child database object type indicating a type of database object according to which any child database object of the parent database object is to be configured. It should be noted that the child database objects may include any other fields.

A second table stores the child database objects of the parent database objects stored in the first table. The child database objects also include various common fields. As shown, such fields are used to store a campaign member id (i.e. a unique identifier of the child database object), the campaign id of the associated parent database object, the child database object type of the child database object as stored by the associated parent database object, and a lead id (i.e. a unique identifier of a lead database object associated with the database object). Of course, it should be noted that the child database objects may include any other fields.

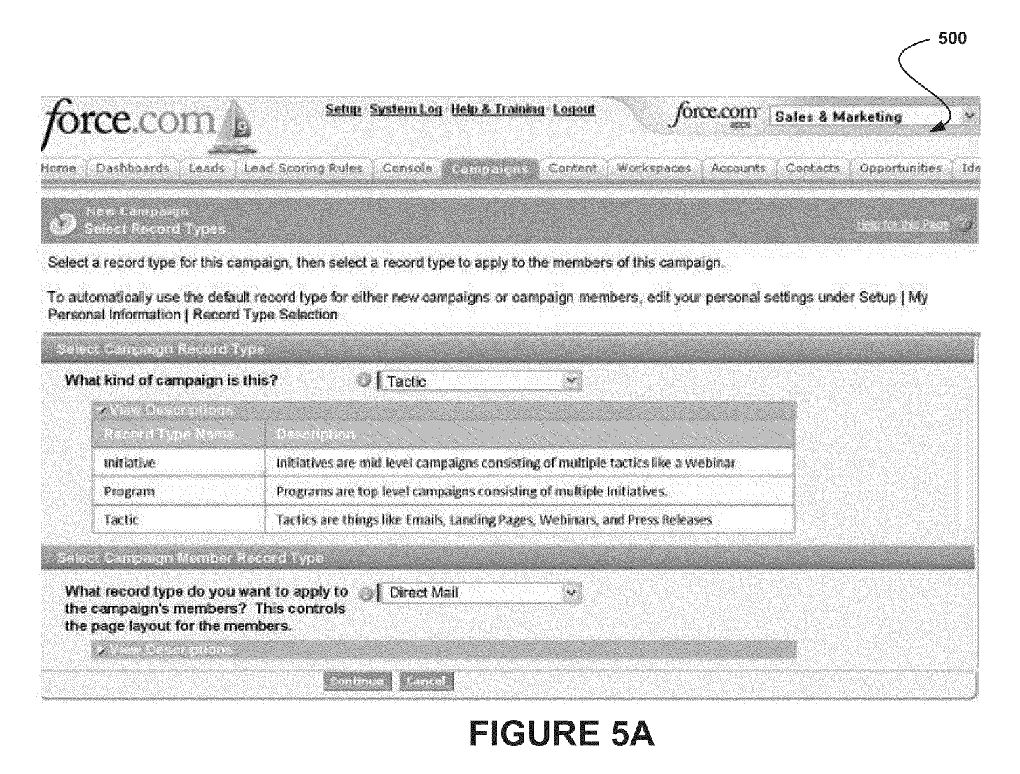

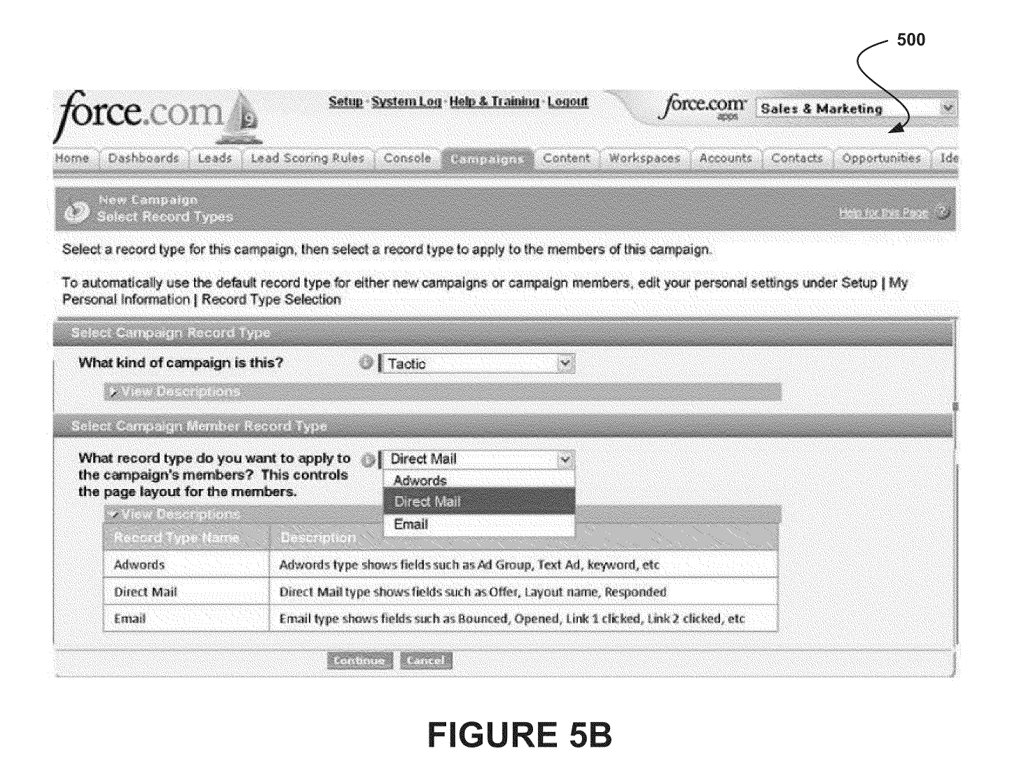

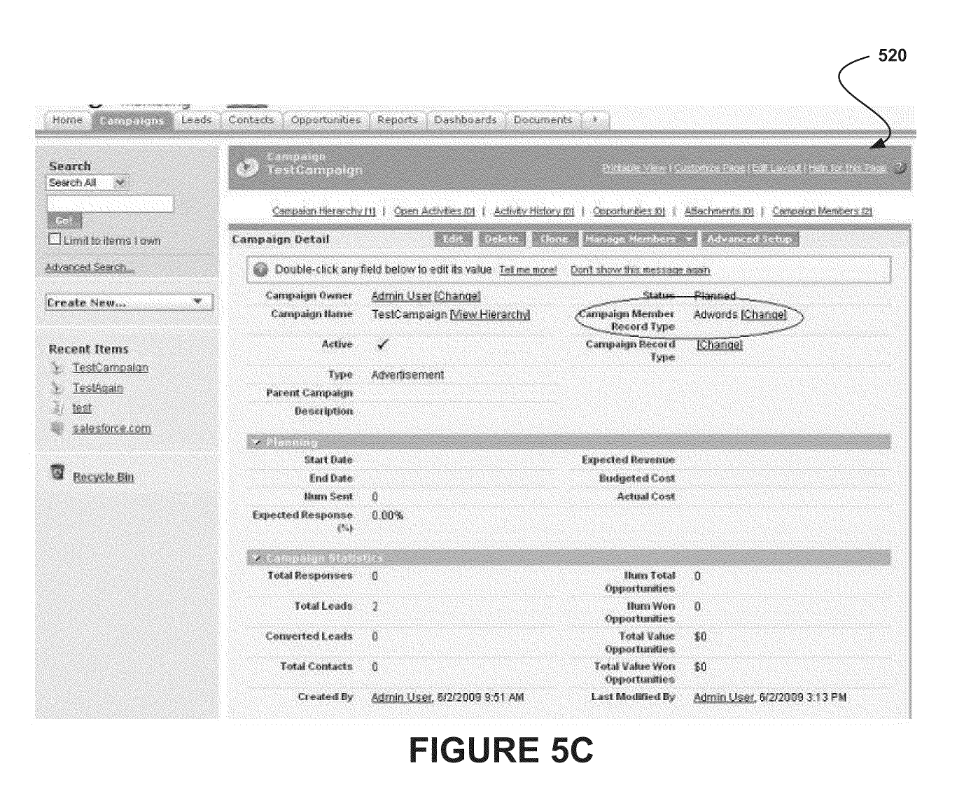

FIGS. 5A-C illustrate graphical user interfaces (GUIs) 500-510 for use in creating a child database object using a child database object type identified from a parent database object, in accordance with an embodiment. As an option, the GUIs 500-510 may be implemented in the context of the functionality of FIGS. 1-4. For example, the GUIs 500-510 may be provided by the multi-tenant on-demand database system described herein. Of course, however, the GUIs 500-510 may be implemented in any desired environment. Again, the aforementioned definitions may apply during the present description.

FIG. 5A shows a GUI 500 for creating a parent database object. As shown, the GUI 500 is used for configuring a type of the parent database object (e.g. initiative, program, or tactic). The GUI 500 is also used for configuring a child database object type (e.g. direct mail) according to which any child database object of the parent database object is configured. FIG. 5B shows the GUI 500 of FIG. 5A, but presenting all available child database object types (e.g. adwords, direct mail, email) for the selected type of the parent database object.

FIG. 5C shows a GUI 510 presenting details of the parent database object associated with the GUI 500 of FIGS. 5A-5B. As highlighted, the child database object type configured for the parent database object may be modified (e.g. updated to another child database object type) using the GUI 510. Any modification may be applied to all child database objects associated to that parent database object.

In one exemplary embodiment, marketers (e.g. tenants of the multi-tenant on-demand database system) may create campaign parent database objects, which are targeted efforts to get prospects to learn more about a product or make a purchase. These efforts may be grouped into categories (i.e. database object types) called “Channels” or “Tactic types” such as Webinars, Google™ Adwords, Tradeshows, and Direct Mail. Campaign Member Record types (i.e. child database object types) may be picklist values that let marketers show a specific page layout for each Channel so that they see Webinar information such as Attended, RSVP Yes, and “Asked Questions” for webinar campaigns, and Direct Mail information such as Direct Mail Template, Personal URL, Sent Date, etc for Direct Mail campaigns. The campaign member (i.e. child database object) page layout serves as a template for that specific channel.

### System Overview

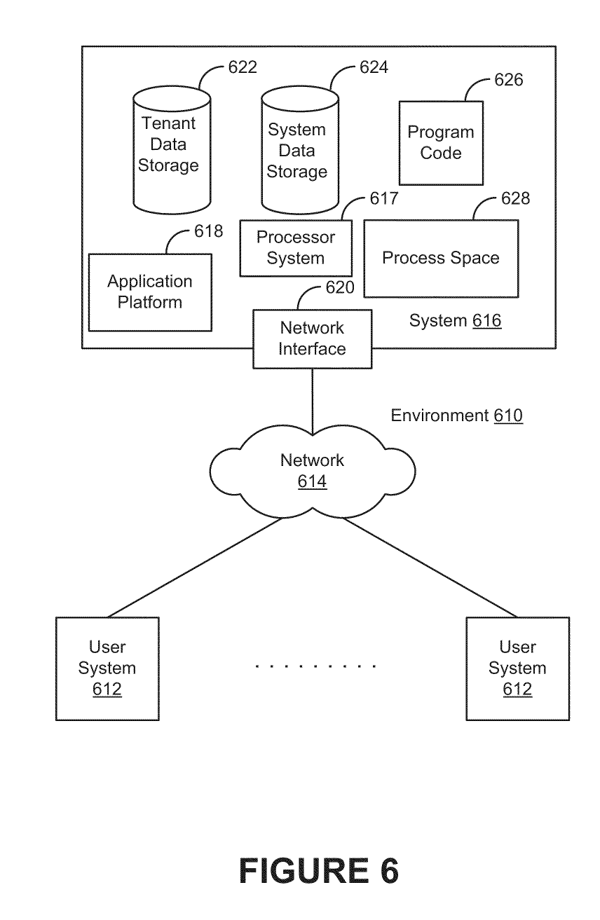

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

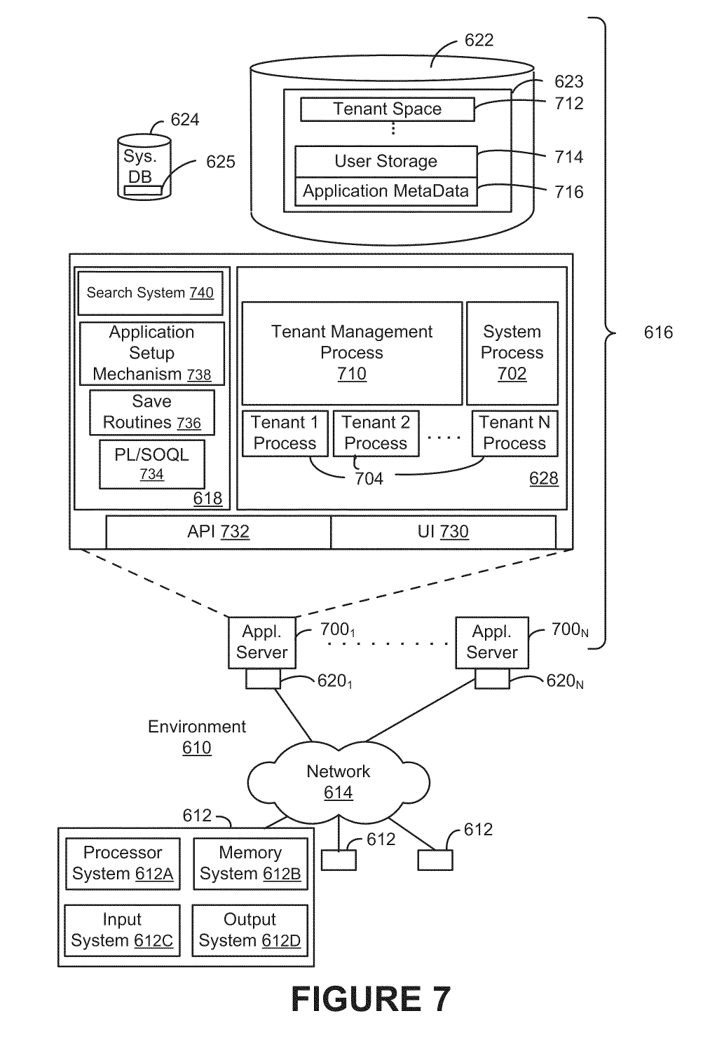

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system, For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714, Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example, invocations to such applications may be coded using PL/SOQL 734 that provides a programming language style interface extension to API 732, A detailed description of some PL/SOQL language embodiments is discussed in commonly owned co-pending U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the (Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method for creating a child database object using a child database object type identified from a parent database object, the method comprising:
receiving a request to create a child database object from a parent database object in a multi-tenant on-demand database system;
identifying, from the parent database object, a child database object type configured for the parent database object; and
creating the child database object using the child database object type identified from the parent database object.

2. The computer program product of claim 1, wherein the child database object is an object that is a child of the parent database object.

3. The computer program product of claim 2, wherein the child database object is the child of the parent database object by virtue of a reference in the child database object to the parent database object.

4. The computer program product of claim 1, wherein the request to create the child database object is received from a graphical user interface (GUI) associated with the parent database object.

5. The computer program product of claim 4, wherein the GUI display details describing the parent database object.

6. The computer program product of claim 1, wherein the child database object type is configured by a user during creation of the parent database object.

7. The computer program product of claim 6, wherein the child database object type is configured by the user selecting the child database object type from a plurality of predetermined child database object types.

8. The computer program product of claim 7, wherein the plurality of predetermined child database object types include a plurality of child database object types predetermined to be associated with a type of the parent database object.

9. The computer program product of claim 1, wherein the child database object type is one of a plurality of predetermined types of child database objects capable of being associated with the parent database object.

10. The computer program product of claim 1, wherein the child database object type is a format for the child database object.

11. The computer program product of claim 1, wherein the child database object type indicates a type of data stored by the child database object.

13. The computer program product of claim 1, wherein the child database object type indicates fields of the child database object.

14. The computer program product of claim 1, wherein the child database object type is configured for the parent database object such that all child database objects of the parent database object are configured to be of the child database object type.

15. The computer program product of claim 1, wherein the child database object type is configured for the parent database object separate from a configured type of the parent database object.

16. The computer program product of claim 15, wherein the child database object type is different from the type of the parent database object.

17. The computer program product of claim 1, wherein creating the child database object using the child database object type includes formatting the child database object according to the child database object type.

18. The computer program product of claim 1, wherein the child database object is created in a first table of the multi-tenant on-demand database system separate from a second table of the multi-tenant on-demand database system storing the parent database object.

19. A method, comprising:
receiving a request to create a child database object from a parent database object in a multi-tenant on-demand database system;
identifying, from the parent database object, a child database object type configured for the parent database object; and
creating the child database object using the child database object type identified from the parent database object, utilizing a processor.

20. An apparatus, comprising:
a processor for:
receiving a request to create a child database object from a parent database object in a multi-tenant on-demand database system;
identifying, from the parent database object, a child database object type configured for the parent database object; and
creating the child database object using the child database object type identified from the parent database object.

21. A method for transmitting code, comprising:
transmitting code to receive a request to create a child database object from a parent database object in a multi-tenant on-demand database system;
transmitting code to identify from the parent database object, a child database object type configured for the parent database object; and
transmitting code to create the child database object using the child database object type identified from the parent database object, utilizing a processor.
